(19) United States
(12) Patent Application Publication
(10) Pub. No.: US 2005/0194884 A1
(43) Pub. Date: Sep. 8, 2005

(54) Flat light source with high and uniform intensity

(76) Inventor: Chih-Yung Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,431

(22) Filed: Feb. 18, 2005

(30) Foreign Application Priority Data
Feb. 20, 2004 (TW) 093104194

(51) Int. Cl. H01J 1/62; H01J 63/04

(52) U.S. Cl. 313/483

(57) ABSTRACT

A flat light source with high and uniform intensity includes a reflective frame having several shapes, a ultraviolet insulated layer and a substrate covered on the reflective frame to form a placing space. The ultraviolet light sources are equipped in the placing space, and the ultraviolet light directly or indirectly excites the fluorescence powder layer to radiate the visible light. The visible light directly or reflectively passes through the ultraviolet insulated layer and the substrate to form a flat light source with high and uniform intensity. The present invention can be achieved without the seal and vacuum processes, so that the cost is reduced and the lamp burned situation is solved. The material or shape is selected accordingly, that will have the manufacture flexibility and convenience. Enlarging the coating area of the fluorescence powder layer and enhancing the reflective rate of the reflective frame improve the illumination efficiency.

### BACKGROUND OF THE INVENTION

1. Field of the Invention

The invention relates to a flat light source, and more particularly, to a flat light source with high and uniform intensity that utilizes the structure design and material selection to improve the illumination efficiency and reduce the manufacturing cost.

2. Description of the Prior Art

The conventional fluorescent lamps are divided into the Cold Cathode Fluorescent Lamp and the Hot Cathode Fluorescent Lamp. The illumination principle is shown in FIGS. 1 and 2. In FIG. 1, when the electrode 10 of the cold cathode fluorescent lamp is applied a high voltage, the electron 12 will emit out from the electrode 10 and is accelerated by the high voltage to collide with the mercury atom 14. After collision, the mercury atom 14 is unstable and immediately comes back to the stable state. At this moment, the mercury atom 14 emits the ultraviolet light 16 with wavelength 253.7 nm since the energy level transition. Then, the ultraviolet light 16 excites the fluorescent powder layer 18 on the lamp wall, and the fluorescent powder layer 18 will absorb it and transfer to the visible light 20.

Please refer to FIG. 2, the illumination principle of the hot cathode fluorescent lamp is similar to that of the cold cathode fluorescent lamp, and the difference is that the cold cathode fluorescent lamp emits the electron from the electrode, but the hot cathode fluorescent lamp emits the electron 32 from the cathode on the electrode 30 when the electrode 30 is applied a high voltage. Similarly, the electron 32 is accelerated by the high voltage and collide with the mercury atom 34. The mercury atom 34 also emits the ultraviolet light 36 with wavelength 253.7 nm since the energy level transition, and the fluorescent powder layer 38 will absorb it and transfer to the visible light 40.

Whatever the cold cathode fluorescent lamp or the hot cathode fluorescent lamp, the manufacture procedures both include the seal and vacuum processes, so the manufacturing cost is hard to lower. In addition, after using a period, the lamp wall near the electrode will be burned black. This is a general ageing situation of conventional lamps and will seriously affect the illumination efficiency.

The flat light source utilizing the above-mentioned illumination principle is popular, such as the Taiwan patent 412,770 “Flat fluorescent lamp for background lighting, and a liquid crystal display device having this flat fluorescent lamp”, the Taiwan patent 412,771 “Gas discharge lamp with dielectrically impeded electrodes”, and the Taiwan patent 412,772 “Flat radiator (2)”. These flat light sources all include a sealed placing space formed by a top board (or top cover) and a bottom board, and a plurality of anode and cathode electrodes are equipped in it. The wall of the placing space is coated a fluorescent powder layer, so the ultraviolet light will be absorbed and transfer to the visible light to be a flat light source. However, the conventional flat light sources have disadvantages of having the burned and ageing situation, the manufacture procedure is complex, and the cost is high with the seal and vacuum processes.

Hence, the present invention discloses a flat light source with high and uniform intensity to overcome the disadvantages.

### SUMMARY OF INVENTION

It is therefore a primary objective of the claimed invention to provide a flat light source with high and uniform intensity utilizing the combination of the reflective frame, the ultraviolet insulated layer and the substrate to form a placing space installed with a plurality of ultraviolet light sources. The ultraviolet light can excite the fluorescent powder layer on the reflective frame wall to radiate the visible light. This design can omit the conventional seal and vacuum processes to reduce the cost.

It is therefore another objective of the claimed invention to provide a flat light source with high and uniform intensity to prevent the burned and ageing situation and enhance the illumination efficiency.

It is therefore a further objective of the claimed invention to provide a flat light source with high and uniform intensity that using the reflective frame to increase the coating area of the fluorescent powder layer to enhance the illumination efficiency.

It is therefore a further objective of the claimed invention to provide a flat light source with high and uniform intensity that using the reflective frame of specific material to enhance the illumination efficiency.

It is therefore a further objective of the claimed invention to provide a flat light source with high and uniform intensity wherein the devices can be selected from different specific materials to improve the convenience and diversification of manufacture.

According to the claimed invention, a flat light source with high and uniform intensity includes a reflective frame coated a fluorescence powder layer, and a ultraviolet insulated layer and a substrate are equipped on the reflective frame to form a placing space. A plurality of ultraviolet light sources are equipped in the placing space, and the emitting light directly or indirectly emit the fluorescence powder layer and excite the visible light. Hence, the present invention can be accomplished without the seal and vacuum processes. In addition, material of the reflective frame can be selected from metal, metallic oxide, plastic, plastic covered metal layer, plastic covered metallic oxide layer and macromolecular compounds, and the reflective frame can be manufactured in many specific shapes that can increase the flexibility of manufacture, adjust the reflective efficiency, and enlarge the coating area of the fluorescence powder layer to enhance the illumination efficiency. Material of the substrate is selected from glass and plastic having transparent conductive layer, and material of the blocking layer is selected from optical film, glass and macromolecular compounds. Material of the fluorescence powder layer is selected from mixture of solvent and fluorescence powder, mixture of solution and fluorescence powder, and mixture of macromolecular compound and fluorescence powder, and the ultraviolet light source is selected from an ultraviolet lamp and a light emitting diode radiating ultraviolet light. Hence, the mater selection is flexible and convenient with several specific materials.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a cold cathode fluorescent lamp according to the prior art.

FIG. 2 is a schematic diagram of a hot cathode fluorescent lamp according to the prior art.

FIGS. 3(a) and 3(b) are schematic diagrams of an embodiment according to the present invention.

FIGS. 4(a) to 4(c) are schematic diagrams of an embodiment with a ultraviolet insulated layer according to the present invention.

FIGS. 5(a) and 5(b) are schematic diagrams of an embodiment with a fluorescence powder layer according to the present invention.

FIGS. 6(a) to 6(c) are schematic diagrams of an embodiment with a blocking layer according to the present invention.

FIGS. 7(a) to 7(e) are schematic diagrams of an embodiment with different shapes of reflective frames according to the present invention.

FIGS. 8(a) and 8(b) are schematic diagrams of an embodiment with different installing types of ultraviolet light sources according to the present invention.

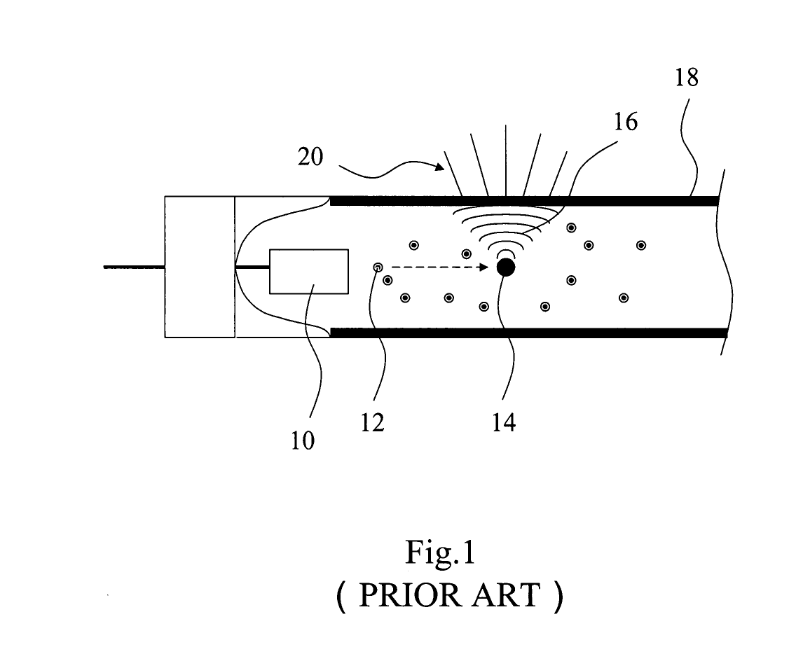

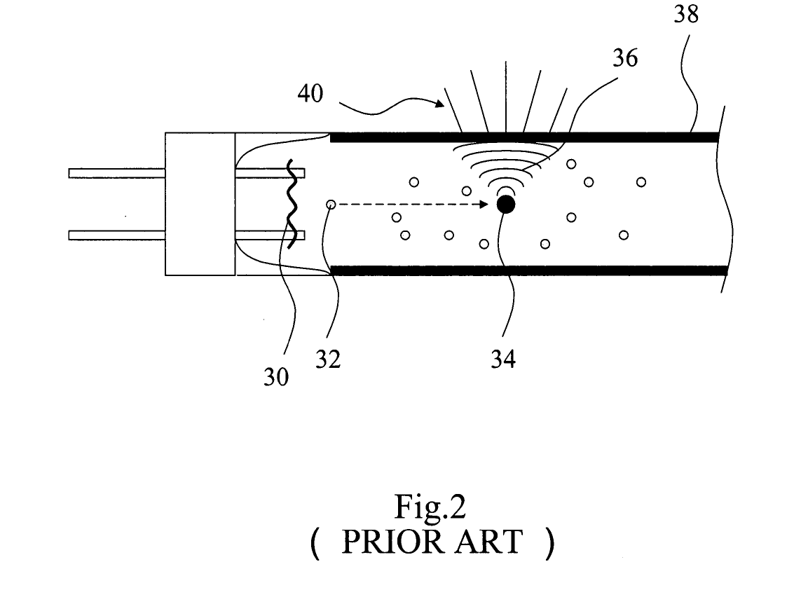

| | | | |
|---|---|---|---|
| 10 | electrode | 12 | electron |
| 14 | mercury atom | 16 | ultraviolet light |
| 18 | fluorescence powder layer | | |
| 20 | visible light | 30 | electrode |
| 32 | electron | 34 | mercury atom |
| 36 | ultraviolet light | 38 | fluorescence powder layer |
| 40 | visible light | 50 | reflective frame |
| 52 | substrate | 54 | ultraviolet light source |
| 56 | fluorescence powder layer | | |
| 58 | ultraviolet insulated layer | | |
| 60 | blocking layer | 62 | bump |

### DETAILED DESCRIPTION

The present invention discloses a flat light source with high and uniform intensity, which utilizing the design of the reflective frame and the selection of material to increase the coating area of the fluorescent powder layer to enhance the illumination efficiency. The devices can be selected from different specific materials to improve the convenience and diversification of manufacture. In addition, the present invention can further omit the seal and vacuum processes to reduce the cost.

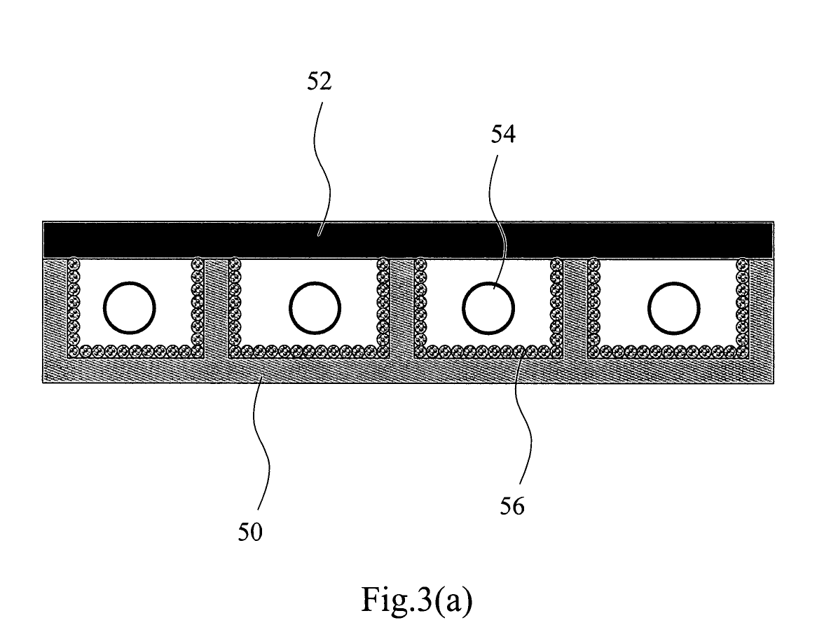

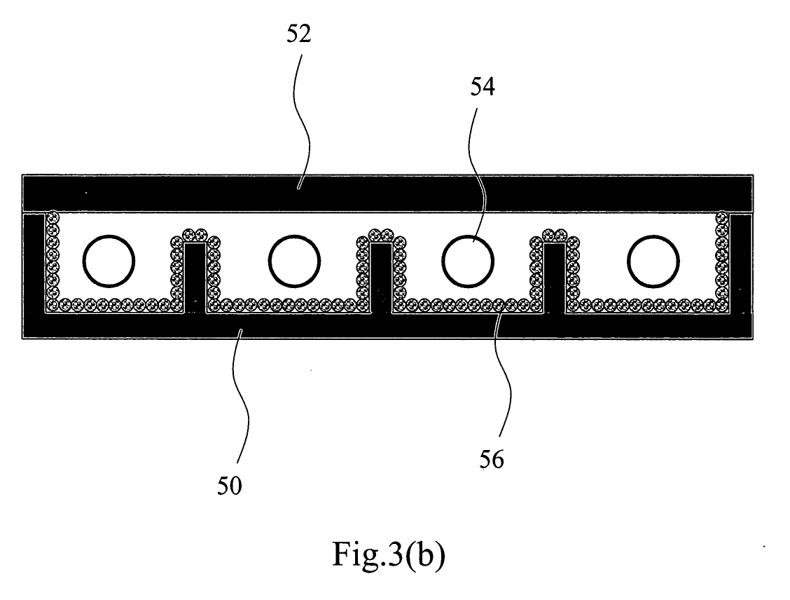

FIGS. 3(a) and 3(b) are schematic diagrams of an embodiment according to the present invention. A reflective frame 50 is covered by a substrate 52 to form a placing space, and there are several intervals in the placing space. In FIG. 3(a), the surrounding and prominent portions of the reflective frame 50 are all touch the substrate 52, and in FIG. 3(b), only the surrounding portion touches the substrate 52. The connection design of the frame and the substrate 52 can be applied to other embodiments and will not be repeated hereinafter. Please refer to FIGS. 3(a) and 3(b), material of the reflective frame 50 can be aluminum, chromium, gold, silver, stainless steel, copper, and their metallic oxide; plastic of Polymethylmethacrylate (PMMA), Polycarbonate (PC) and Polyethylene Terephthalate (PET); plastic coated with aluminum, TiN, TiC, chromium, and their metallic oxide; or the compound material of plastic and white ceramic powder wherein material of the white ceramic powder is selected from MgO, TiO₂ and Al₂O₃. In addition, material of the substrate 52 is selected from glass or plastic, wherein material of the glass is selected from soda-lime glass, quartz glass, sodium glass, borosilicate glass, boron lead sodium glass and nonleaded glass; and material of the plastic is selected from Polymethylmethacrylate (PMMA), Polycarbonate (PC) and Polyethylene Terephthalate (PET). The surface of the substrate can further have a transparent conductive layer, such as indium tin oxide (ITO), In₂O₃ and SnO₂.

As shown in FIGS. 3(a) and 3(b), the placing space between the substrate 52 and the reflective frame 50 can be placed several ultraviolet light source 54 which is a ultraviolet lamp or a light emitting diode radiating ultraviolet light. In the placing space, a fluorescence powder layer 56 can be further equipped on the wall of the reflective frame 50, that can absorb the ultraviolet light with wavelength 200 nm to 400 nm to radiate the visible light. The fluorescence powder layer 56 is selected from mixture of solvent and fluorescence powder, mixture of solution and fluorescence powder, and mixture of macromolecular compound and fluorescence powder. The ultraviolet light from the ultraviolet light source 54 can emit to the fluorescence powder layer 56 and excite the fluorescence powder layer 56 to radiate the visible light. The visible light will be reflected by the reflective frame 50 and passes through the substrate 52 to form a flat light source with high and uniform intensity.

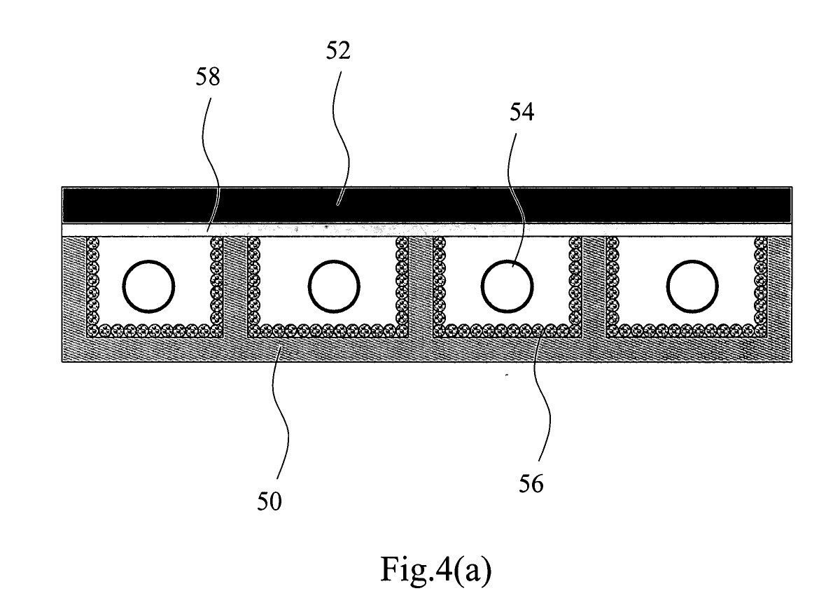

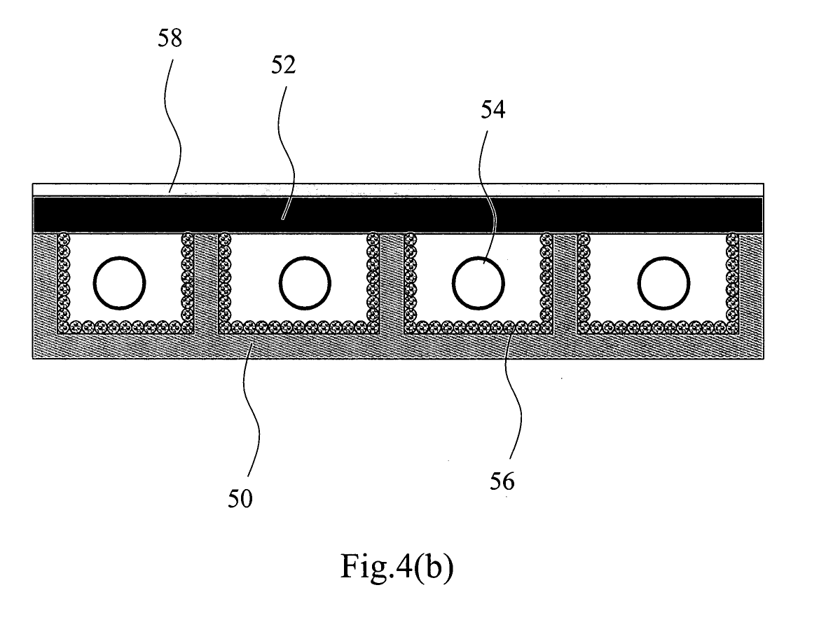

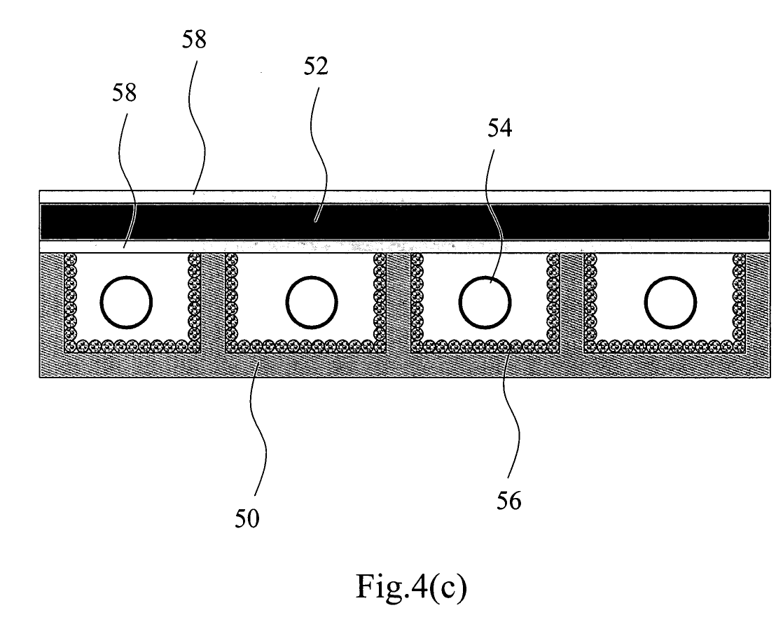

For preventing the ultraviolet light directly or indirectly passing through the substrate 52, one or both sides of the substrate 52 can be coated a ultraviolet insulated layer 58. As shown in FIGS. 4(a) to 4(c), the ultraviolet insulated layer 58 can be a optical film selected from CaF₂, Na₃AlF₆, AlF₃, ThF₄, LaF₃, NdF₃, CeF₃, PbF₂, ZnS, CdS, ZnSe, ZnTe, Sb₂S₃, Ge₃₀As₁₇Te₃₀Se₂₃, InSb, InAs, PbTe, Si, Ge, SiO₂, SiO, Al₂O₃, Nd₂O₃, Cd₂O₃, ThO₂, Y₂O₃, Sc₂O₃, La₂O₃, Pr₆O₁₁,HfO₂, ZnO, TiO, PbO, ZrO₂, TiO₂, ZrTiO₄, MgO, CeO₂, Ta₂O₅, MgF₂, NaF and LiF; glass whose material selected from soda-lime glass, quartz glass, sodium glass, borosilicate glass, boron lead sodium glass and nonleaded glass; or a macromolecular compound. The combination of the ultraviolet insulated layer 58 and selection of material can be applied to other embodiments and will not be repeated hereinafter.

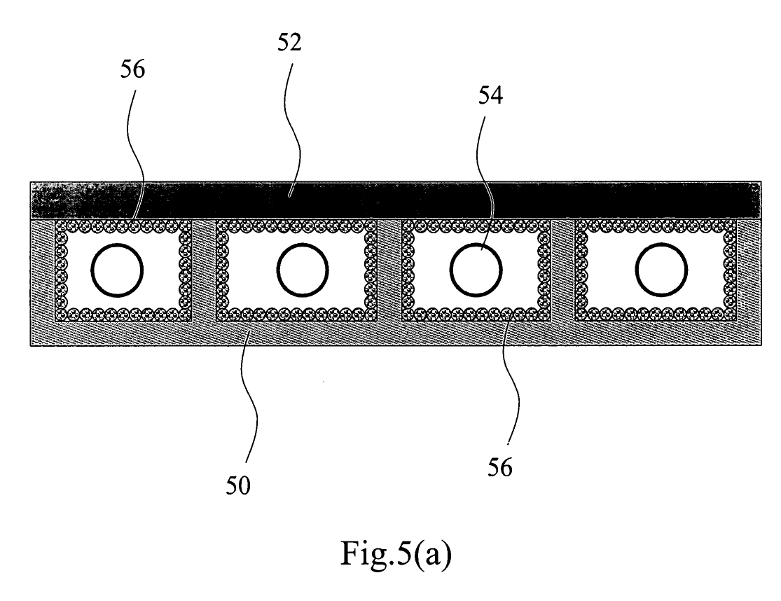

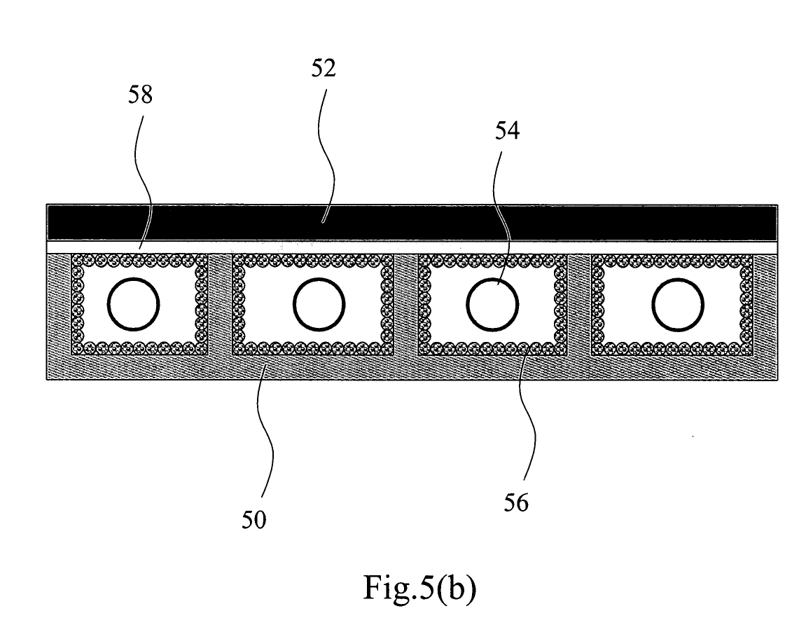

Please refer to FIGS. 5(a) and 5(b), top of the ultraviolet light source 54 can be further designed the fluorescence powder layer 56. The fluorescence powder layer 56 can be designed on the substrate 52 as shown in FIG. 5(a), or can be designed on the ultraviolet insulated layer 58 as shown in FIG. 5(b). The fluorescence powder layer 56 can enlarge the illuminating area of the visible light and enhance the illumination efficiency of the present invention. Similarly, the design of forming the fluorescence powder layer 56 on top of the ultraviolet light source 54 can be applied to other embodiments.

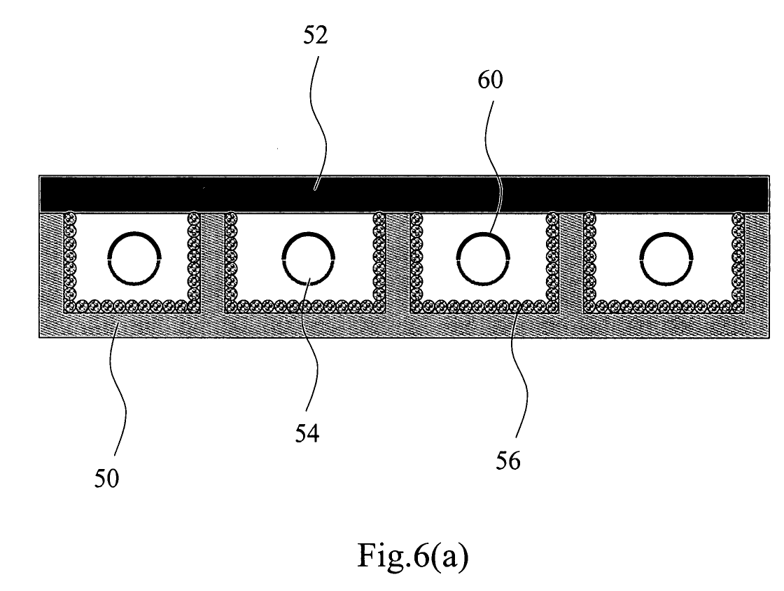

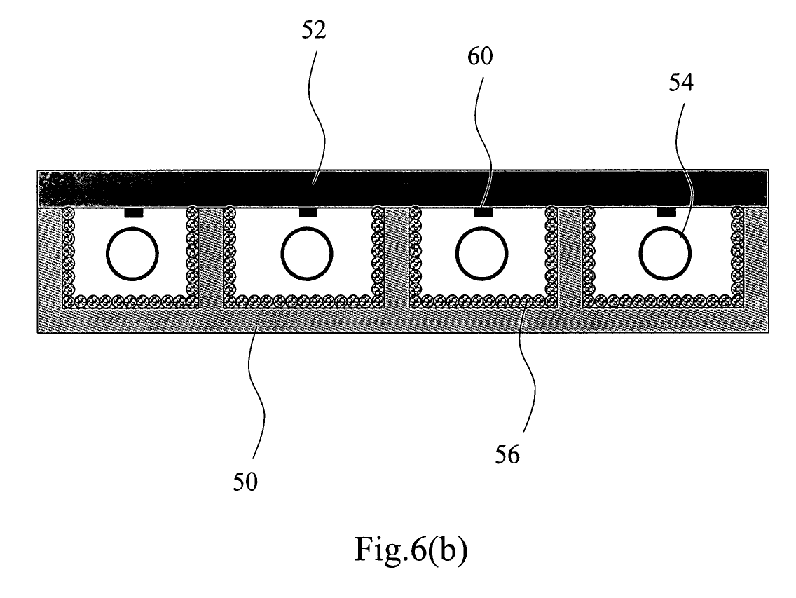

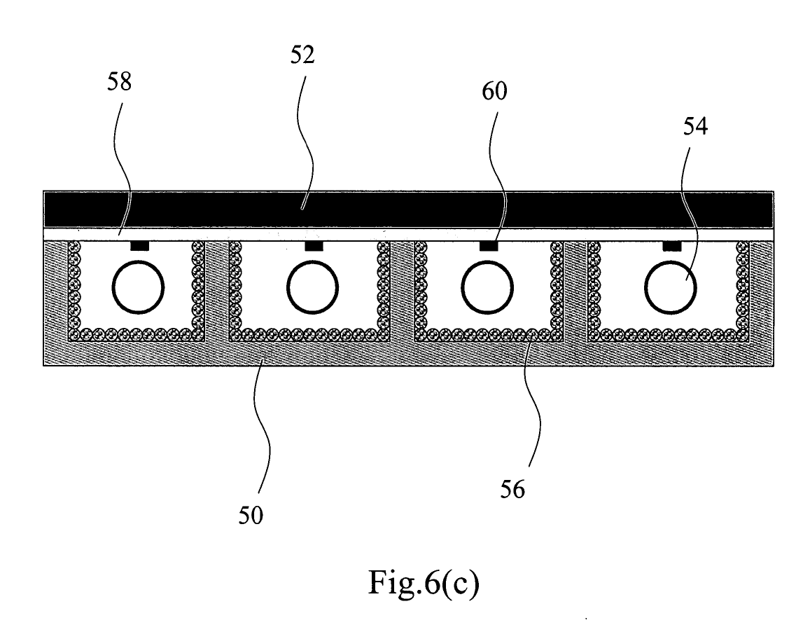

FIGS. 6(a) to 6(c) show a blocking layer 60 on the ultraviolet light source 54. The blocking layer 60 can reflect the ultraviolet light to the substrate 52 or the ultraviolet insulated layer 58, and reflect the ultraviolet light to the fluorescence powder layer 56 , and then the fluorescent powder layer 18 will absorb it and transfer to the visible light 40. Material of the blocking layer 60 is selected from metal, metallic oxide and optical film, wherein material of the metal is selected from aluminum, chromium, gold, silver, stainless steel and copper, and the optical film is selected from CaF₂, Na₃AlF₆, AlF₃, ThF₄, LaF₃, NdF₃, CeF₃, PbF₂, ZnS, CdS, ZnSe, ZnTe, Sb₂S₃, Ge₃₀As₁₇Te₃₀Se₂₃, InSb, InAs, PbTe, Si, Ge, SiO₂, SiO, Al₂O₃, Nd₂O₃, Cd₂O₃, ThO₂, Y₂O₃, Sc₂O₃, La₂O₃, Pr₆O₁₁, HfO₂, ZnO, TiO, PbO, ZrO₂, TiO₂, ZrTiO₄, MgO, CeO₂, Ta₂O₅, MgF₂, NaF and LiF. The blocking layer 60 can be directly coated on upper half surface of the ultraviolet light source 54 as shown in FIG. 6(a), or can be equipped between the ultraviolet light source 54 and the substrate 52 or the ultraviolet insulated layer 58, as shown in FIGS. 6(b) and 6(c). The width of the blocking layer 60 shown in FIGS. 6(b) and 6(c) is less than half of the width or diameter of the ultraviolet light source 54 to avoid blocking the visible light. Similarly, the design of the blocking layer 60 can be also applied to other embodiments.

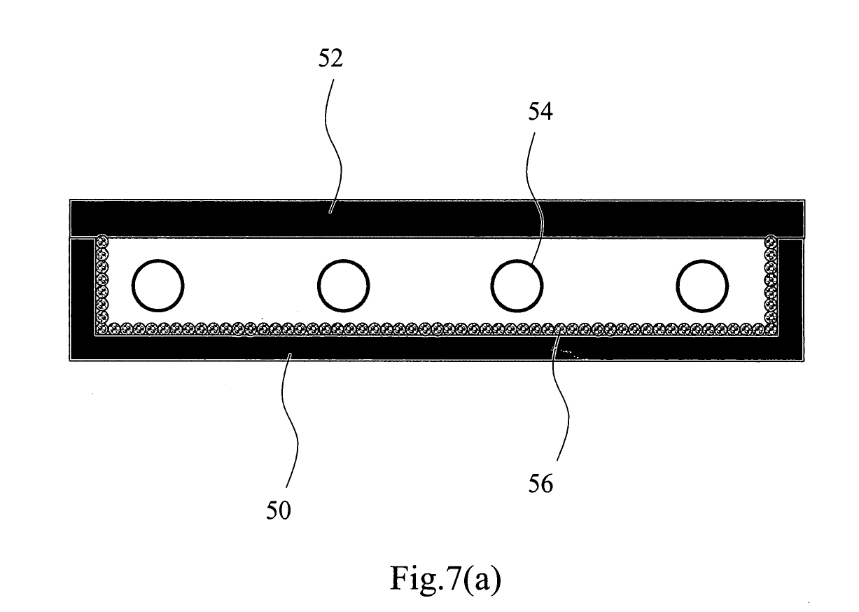

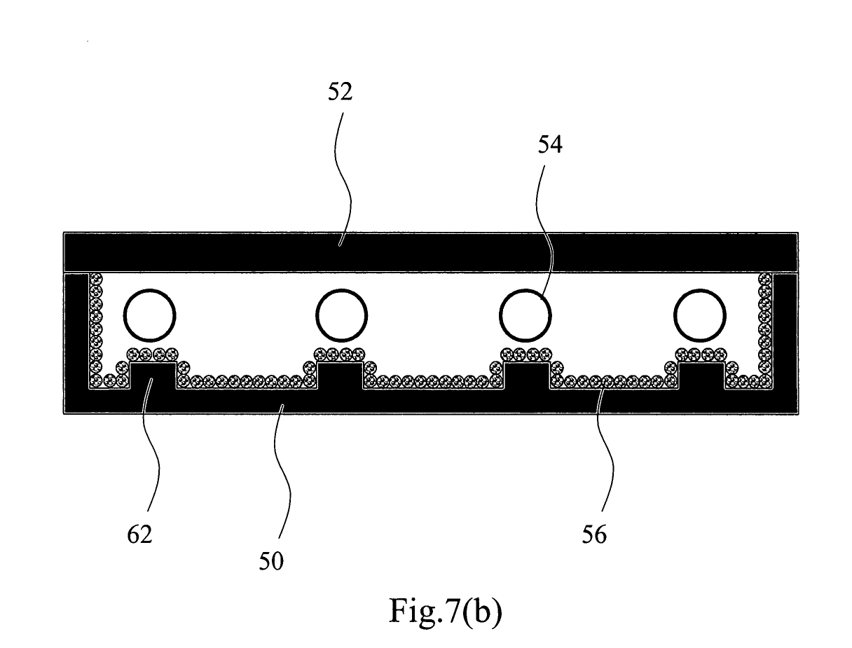

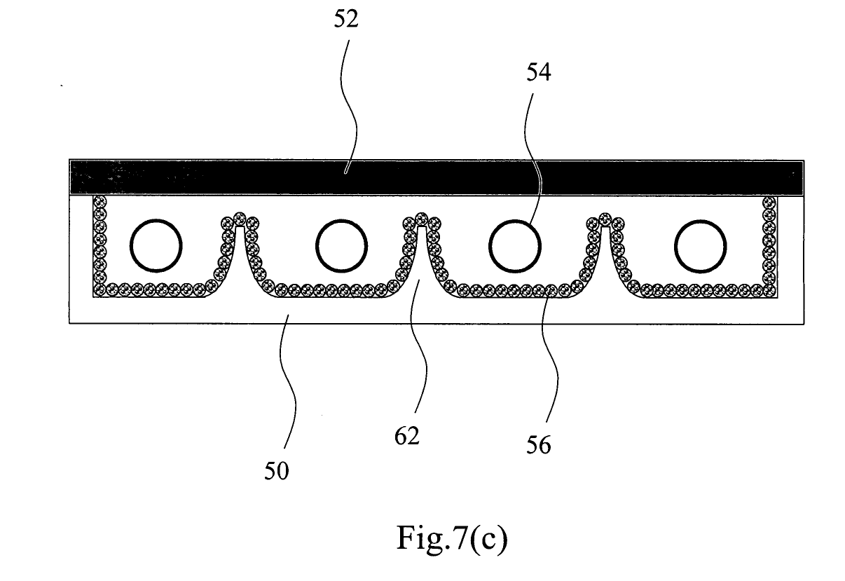

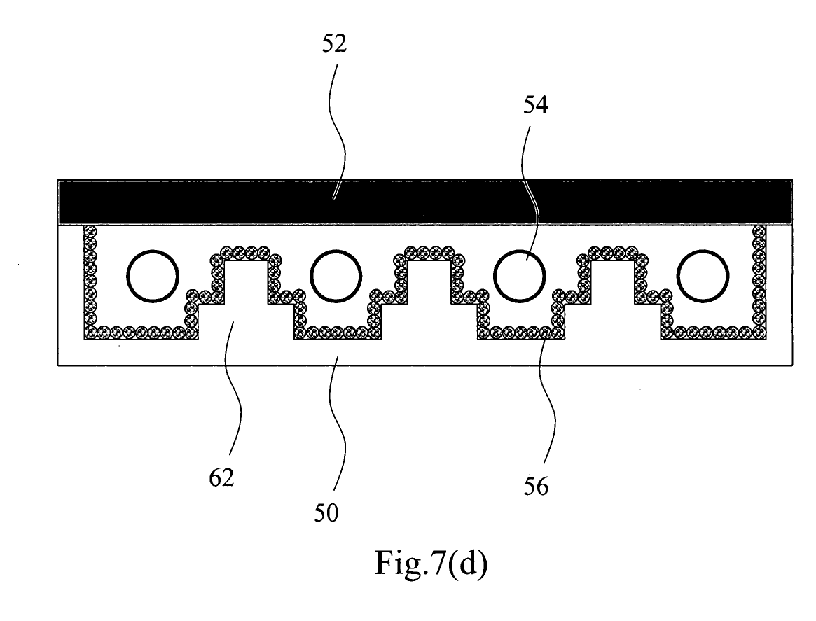

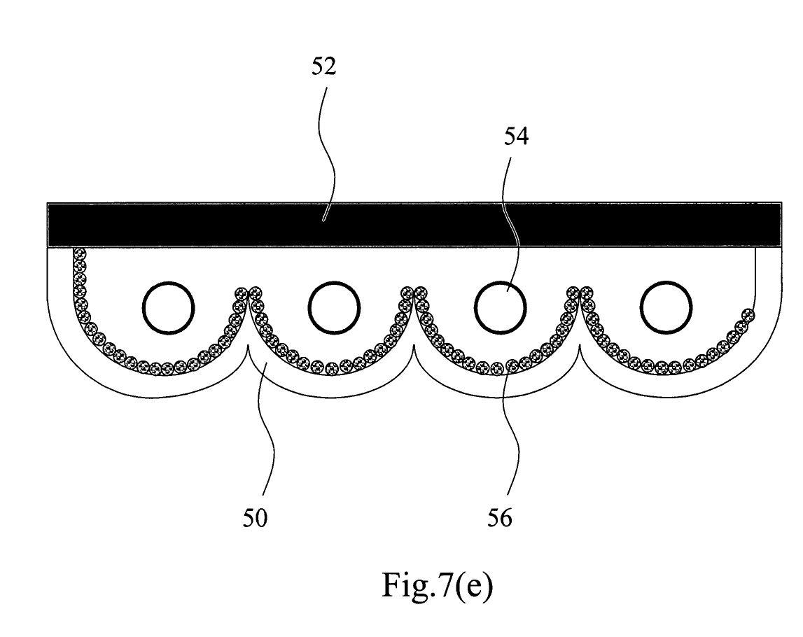

Please refer to FIGS. 7(a) to 7(e), which are schematic diagrams of an embodiment with different shapes of reflective frames 50 according to the present invention. As shown in FIG. 7(a), the reflective frame 50 can be a simple placing frame including a side surface surrounding the placing space and a bottom surface, and the bottom surface is surface-prepared to form a horizontal pattern, vertical pattern, twill pattern or floral pattern. The reflective frames 50 with different patterns have different reflective result, and the pattern design can be applied to all the reflective frames 50 with bottom surfaces. FIG. 7(b) shows a reflective frame 50 with several bump 62. The ultraviolet light source 54 is designed on each bump 62, and shape of the bump 62 can be rectangle, trapezoid, triangle, wavy shape, arc, stair shape and other polygons. FIGS. 7(c) and 7(d) show two reflective frames 50 with bumps 60 in different shapes, and the ultraviolet light source 54 is equipped in the intervals between the bumps 62. Shape of the bump 62 can be rectangle (refer to FIG. 3(b)), trapezoid, triangle, arc and other polygons. The reflective frame 50 in FIG. 7(e) is an arc continuous trench, and the ultraviolet light source 54 is installed in each trench. Shape of the trench can be trapezoid, triangle, rectangle, stair shape and other polygons. In the embodiments of FIGS. 7(b) to 7(e), more than one ultraviolet light source can be designed on each bump, in each interval, or in each trench to match different requirements.

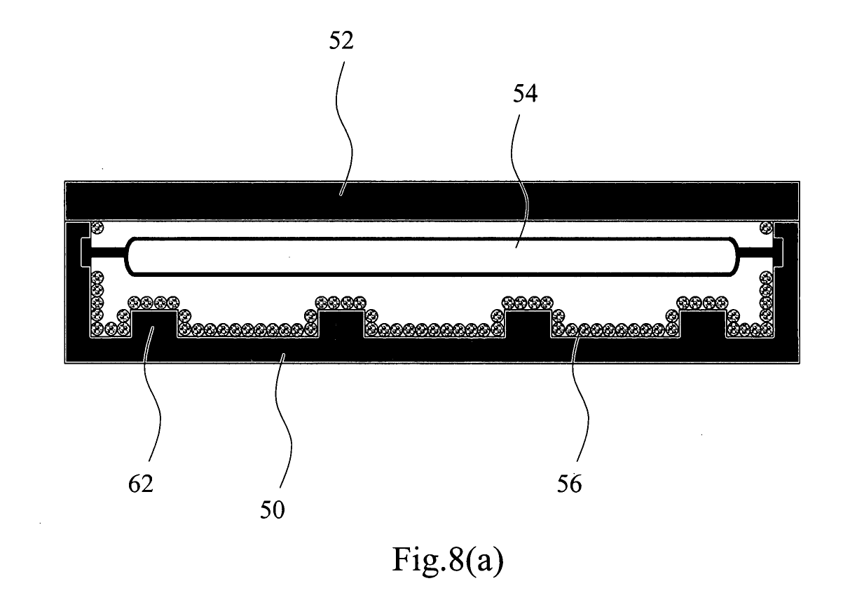

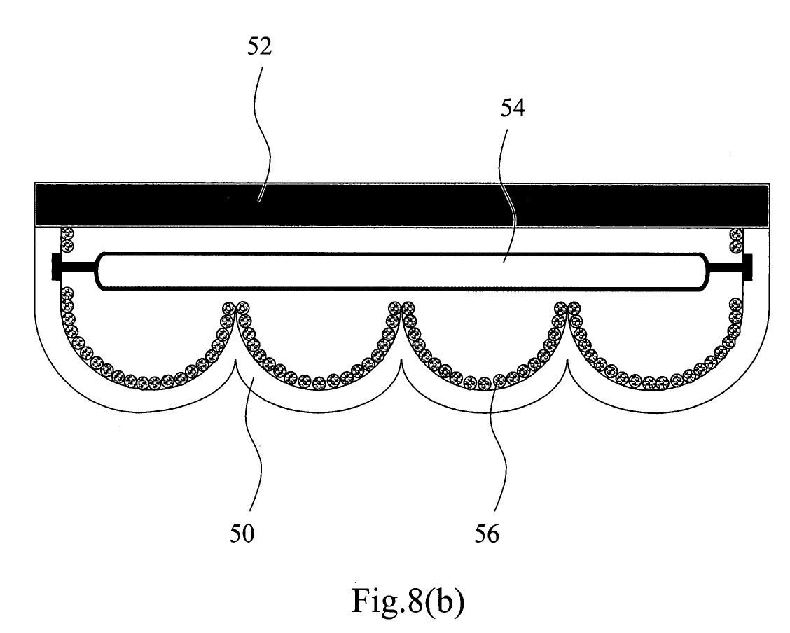

FIGS. 8(a) and 8(b) show a reflective frame 50 having the bump 62 and a reflective frame 50 composed of the continuous trenches. The difference between FIGS. 8(a)(b) and FIGS. 7(b)(e) is: in FIGS. 8(a)(b), the ultraviolet light sources 54 are formed at extending direction vertical to the bump 62 and vertical to the trench. This kind of design can improve the flexibility of combination, and make the diversification of manufacture. Similarly, this design can be applied to other embodiments having the placing space.

In the embodiments of FIGS. 7 and 8, the reflective frame can be also formed by a side surface surrounding the placing space and a bottom surface, wherein shape of the bottom surface is regular curve or irregular curve.

In contrast to the prior art, the present invention can provide a flat light source with high and uniform intensity without using the seal and vacuum processes, so that the manufacturing cost is reduced and the lamp burned situation is solved. In addition, the present invention can select the specific material in accordance with the cost or market situation, and have the manufacture flexibility and convenience. The shape of the reflective frame can have various changes to enlarge the coating area of the fluorescence powder layer, and the metallic reflective frame can enhance the reflective rate and improve the illumination efficiency.

Those skilled in the art will readily observe that numerous modifications and alterations of the device may be made while retaining the teachings of the invention. Accordingly, the above disclosure should be construed as limited only by the metes and bounds of the appended claims.

1. A flat light source with high and uniform intensity comprises:
a reflective frame;
a substrate covered on the reflective frame to form at least one placing space;
at least one fluorescence powder layer placed on the reflective frame in the placing space; and
a plurality of ultraviolet light source installed in the placing space.

2. The flat light source with high and uniform intensity of claim 1, wherein material of the substrate is selected from glass and plastic.

3. The flat light source with high and uniform intensity of claim 2, wherein material of the glass is selected from soda-lime glass, quartz glass, sodium glass, borosilicate glass, boron lead sodium glass and nonleaded glass.

4. The flat light source with high and uniform intensity of claim 2, wherein material of the plastic is selected from Polymethylmethacrylate (PMMA), Polycarbonate (PC) and Polyethylene Terephthalate (PET).

5. The flat light source with high and uniform intensity of claim 1, wherein the substrate has a upper and a lower surfaces, and a transparent conductive layer is located on any surface of the substrate.

6. The flat light source with high and uniform intensity of claim 5, wherein the transparent conductive layer is selected from indium tin oxide (ITO), In₂O₃ and SnO₂.

7. The flat light source with high and uniform intensity of claim 1, wherein the substrate has a upper and a lower surfaces, and a transparent conductive layer is located on each surface of the substrate.

8. The flat light source with high and uniform intensity of claim 7, wherein the transparent conductive layer is selected from indium tin oxide (ITO), In₂O₃ and SnO₂.

9. The flat light source with high and uniform intensity of claim 1 can further have a ultraviolet insulated layer located on at least one surface of the substrate.

10. The flat light source with high and uniform intensity of claim 9, wherein material of the ultraviolet separation layer is selected from optical film, glass and macromolecular compound.

11. The flat light source with high and uniform intensity of claim 10, wherein the optical film is selected from CaF₂, Na₃AlF₆, AlF₃, ThF₄, LaF₃, NdF₃, CeF₃, PbF₂, ZnS, CdS, ZnSe, ZnTe, Sb₂S₃, Ge₃₀As₁₇Te₃₀Se₂₃, InSb, InAs, PbTe, Si, Ge, SiO₂, SiO, Al₂O₃, Nd₂O₃, Cd₂O₃, ThO₂, Y₂O₃, Sc₂O₃, La₂O₃, Pr₆O₁₁, HfO₂, ZnO, TiO, PbO, ZrO₂, TiO₂, ZrTiO₄, MgO, CeO₂, Ta₂O₅, MgF₂, NaF and LiF.

12. The flat light source with high and uniform intensity of claim 10, wherein material of the glass is selected from soda-lime glass, quartz glass, sodium glass, borosilicate glass, boron lead sodium glass and nonleaded glass.

13. The flat light source with high and uniform intensity of claim 9, wherein the ultraviolet separation layer in the placing space can be further equipped the fluorescence powder layer when the ultraviolet insulated layer locates between the reflective frame and the substrate.

14. The flat light source with high and uniform intensity of claim 1, wherein the substrate in the placing space can be further equipped the fluorescence powder layer.

15. The flat light source with high and uniform intensity of claim 1, wherein the fluorescence powder layer is selected from mixture of solvent and fluorescence powder, mixture of solution and fluorescence powder, and mixture of macromolecular compound and fluorescence powder.

16. The flat light source with high and uniform intensity of claim 1, wherein the fluorescence powder layer can absorb the ultraviolet light with wavelength 200 nm to 400 nm to radiate visible light.

17. The flat light source with high and uniform intensity of claim 1, wherein the ultraviolet light source is selected from an ultraviolet lamp without fluorescence powder.

18. The flat light source with high and uniform intensity of claim 1, wherein a blocking layer is further formed between the ultraviolet light source and the substrate, position of the blocking layer is selected from surface of the ultraviolet light source and top of the ultraviolet light source, the ultraviolet light directly emitted to the substrate can be reflected to the fluorescence powder layer by the blocking layer.

19. The flat light source with high and uniform intensity of claim 18, wherein the blocking layer covers half of surface of the ultraviolet light source when the blocking layer locates on surface of the ultraviolet light source, and width of the blocking layer is smaller than width of the ultraviolet light source when the blocking layer locates on top of the ultraviolet light source.

20. The flat light source with high and uniform intensity of claim 18, wherein material of the blocking layer is selected from metal, metallic oxide and optical film.

21. The flat light source with high and uniform intensity of claim 20, wherein material of the metal is selected from aluminum, chromium, gold, silver, stainless steel and copper.

22. The flat light source with high and uniform intensity of claim 20, wherein the optical film is selected from CaF₂, Na₃AlF₆, AlF₃, ThF₄, LaF₃, NdF₃, CeF₃, PbF₂, ZnS, CdS, ZnSe, ZnTe, Sb₂S₃, Ge₃₀As₁₇Te₃₀Se₂₃, InSb, InAs, PbTe, Si, Ge, SiO₂, SiO, Al₂O₃, Nd₂O₃, Cd₂O₃, ThO₂, Y₂O₃, Sc₂O₃, La₂O₃, Pr₆O₁₁, HfO₂, ZnO, TiO, PbO, ZrO₂, TiO₂, ZrTiO₄, MgO, CeO₂, Ta₂O₅, MgF₂, NaF and LiF.

23. The flat light source with high and uniform intensity of claim 1, wherein material of the reflective frame is selected from metal, metallic oxide, plastic, plastic covered metal layer, plastic covered metallic oxide layer and compound material of plastic and white ceramic powder.

24. The flat light source with high and uniform intensity of claim 23, wherein material of the metal is selected from aluminum, chromium, gold, silver, stainless steel and copper.

25. The flat light source with high and uniform intensity of claim 23, wherein material of the plastic is selected from Polymethylmethacrylate (PMMA), Polycarbonate (PC) and Polyethylene Terephthalate (PET).

26. The flat light source with high and uniform intensity of claim 23, wherein material of the metal layer is selected from aluminum, TiN, TiC and chromium.

27. The flat light source with high and uniform intensity of claim 23, wherein material of the white ceramic powder is selected from MgO, TiO₂and Al₂O₃.

28. The flat light source with high and uniform intensity of claim 1, wherein the reflective frame has a side surface surrounding the placing space and a bottom surface, the bottom surface is formed a plurality of bumps and top of each bump is formed at least one ultraviolet light source.

29. The flat light source with high and uniform intensity of claim 1, wherein the reflective frame has a side surface surrounding the placing space and a bottom surface, the bottom surface is formed at least one bump and the bump separates the placing space to form a plurality of intervals.

30. The flat light source with high and uniform intensity of claim 29, wherein the bump and the substrate are at a distance.

31. The flat light source with high and uniform intensity of claim 29, wherein the bump touches the substrate.

32. The flat light source with high and uniform intensity of claim 29, wherein an ultraviolet insulated layer can be further formed between the substrate and the reflective frame, and the bump and the ultraviolet insulated layer are at a distance.

33. The flat light source with high and uniform intensity of claim 29, wherein a ultraviolet insulated layer can be further formed between the substrate and the reflective frame, and the bump touches the ultraviolet insulated layer.

34. The flat light source with high and uniform intensity of claim 29, wherein shape of the bump is selected from rectangle, trapezoid, triangle, wavy shape, arc, stair shape and other polygons.

35. The flat light source with high and uniform intensity of claim 29, wherein at least one ultraviolet light source is formed in each interval.

36. The flat light source with high and uniform intensity of claim 29, wherein the ultraviolet light source is formed at extending direction vertical to the bump.

37. The flat light source with high and uniform intensity of claim 1, wherein the reflective frame is a continuous trench.

38. The flat light source with high and uniform intensity of claim 37, wherein at least one ultraviolet light source is formed in each trench.

39. The flat light source with high and uniform intensity of claim 37, wherein the ultraviolet light source is formed at extending direction vertical to the trench.

40. The flat light source with high and uniform intensity of claim 37, wherein shape of the trench is selected from arc, trapezoid, triangle, rectangle, stair shape, wavy shape and other polygons.

41. The flat light source with high and uniform intensity of claim 1, wherein the reflective frame has a side surface surrounding the placing space and a bottom surface, the bottom surface is surface-prepared to form a specific pattern.

42. The flat light source with high and uniform intensity of claim 41, wherein the specific pattern is selected from horizontal pattern, vertical pattern, twill pattern and floral pattern.

43. The flat light source with high and uniform intensity of claim 1, wherein the reflective frame has a side surface surrounding the placing space and a bottom surface, shape of the bottom surface is selected from regular curve and irregular curve.
